(19) United States
(12) Patent Application Publication
(10) Pub. No.: US 2026/0210621 A1
(43) Pub. Date: Jul. 23, 2026

(54) REFRIGERATOR AND METHOD OF CONTROLLING THE SAME

(71) Applicant: SAMSUNG ELECTRONICS CO., LTD., Suwon-si (KR)

(72) Inventors: Hoyoung MAENG, Suwon-si (KR); Byoungwoo KO, Suwon-si (KR); Jihyun RYU, Suwon-si (KR); Dongseok LEE, Suwon-si (KR); Jongsoo HONG, Suwon-si (KR)

(73) Assignee: SAMSUNG ELECTRONICS CO., LTD., Suwon-si (KR)

(21) Appl. No.: 19/439,089

(22) Filed: Jan. 2, 2026

Related U.S. Application Data
(63) Continuation of application No. PCT/KR2025/017771, filed on Oct. 31, 2025.

(30) Foreign Application Priority Data
Jan. 21, 2025 (KR) 10-2025-0008939

(51) Int. Cl. F25D 23/02; E05F 15/73; F25D 29/00

(52) U.S. Cl. CPC F25D 23/028; E05F 15/73; F25D 29/00; E05F 2015/765; E05Y 2900/31; F25D 2323/021

(57) ABSTRACT

According to an embodiment, a refrigerator may include at least one storage compartment, at least one door configured to open and close the at least one storage compartment, at least one sensor, and at least one processor. The at least one processor may be configured to obtain point cloud data using the at least one sensor, identify a gesture of a user positioned within a first distance from the refrigerator based on the point cloud data, and perform control to open a door from among the at least one door based on the gesture being identified.

### CROSS-REFERENCE TO RELATED APPLICATIONS

This application is a continuation application of International Application No. PCT/KR2025/017771, filed on Oct. 31, 2025, in the Korean Intellectual Property Receiving Office, which claims priority from Korean Patent Application No. 10-2025-0008939, filed on Jan. 21, 2025, in the Korean Intellectual Property Office, the disclosures of which are hereby incorporated by reference herein in their entireties.

### TECHNICAL FIELD

Various embodiments of the disclosure relate to a refrigerator, and more particularly, to a refrigerator that automatically opens at least one door and a method of controlling the same.

### BACKGROUND ART

A refrigerator is a device that stores objects such as food in a fresh state using a refrigeration cycle, and may include a freezing chamber that stores objects in a sub-zero temperature state, and a refrigerating chamber that stores objects in an above-freezing temperature state.

With the recent spread of smart homes and the development of Internet of Things (IoT) technology, a refrigerator may perform various innovative functions such as voice control, remote control through a smartphone application, and food management using internal cameras.

The refrigerator may include at least one door according to the number or structure of storage compartments. The doors of the refrigerator may be used to put objects in the storage compartment or take them out. The doors of the refrigerator are closed to prevent leakage of cold air out of the storage compartment, keeping the temperature inside the storage compartment constant.

The opening of the door of the refrigerator is performed by a user's separate manipulation based on a physical contact. However, as the function of the refrigerator being smarter, refrigerators capable of automatic door opening based on the user's intention without physical contact are being suggested.

### DISCLOSURE OF INVENTION

### Solution to Problems

Various examples of the disclosure may provide a refrigerator and a method of controlling the same that generate a point cloud using a sensor and automatically open a door according to a user's intention by identifying a gesture of the user based on the point cloud.

According to an example, a refrigerator may include at least one storage compartment, at least one door configured to open and close the at least one storage compartment, at least one sensor, and at least one processor. The at least one processor may be configured to obtain point cloud data using the at least one sensor, identify a gesture of a user positioned within a first distance from the refrigerator based on the point cloud data, and perform control to open a door from among the at least one door based on the gesture being identified.

According to an example, a method of controlling a refrigerator may include obtaining point cloud data using at least one sensor, identifying a gesture of a user positioned within a first distance from the refrigerator based on the point cloud data, and opening a door of the refrigerator based on the gesture being identified.

According to an example, a refrigerator may identify a gesture of a user with high accuracy by detecting the gesture of the user based on point cloud data obtained by a radar sensor. According to an example, a refrigerator may increase the accuracy of determining a gesture of a user by learning characteristics of the user. A refrigerator may increase convenience and efficiency in using the refrigerator by automatically opening a door according to a user's intention. A refrigerator may provide safety in use by deactivating an automatic door opening function in case that a gesture of a restricted user and/or an animal is identified.

Effects achievable in examples of the disclosure are not limited to the above-mentioned effects, but other effects not mentioned may be apparently derived and understood by one of ordinary skill in the art to which examples of the disclosure pertain, from the following description. In other words, unintended effects in practicing examples of the disclosure may also be derived by one of ordinary skill in the art from examples of the disclosure.

### BRIEF DESCRIPTION OF DRAWINGS

FIG. 1 is a front view illustrating a refrigerator according to an embodiment of the disclosure.

FIG. 2 is a perspective view illustrating an inside of a refrigerator according to an embodiment of the disclosure.

FIG. 3 is a perspective view illustrating an outer door opened in a refrigerator according to an example.

FIG. 4 is a block diagram illustrating a configuration of a refrigerator according to an example of the disclosure.

FIG. 5 is a flowchart illustrating an operation of a refrigerator according to an example of the disclosure.

FIGS. 6A and 6B illustrate an example method of obtaining and processing point cloud data.

FIG. 7 is a view illustrating a process in which a refrigerator according to an example of the disclosure determines a gesture of a user from point cloud data using an artificial intelligence model.

FIG. 8 is a block diagram illustrating a configuration of a radar sensor according to an example.

FIGS. 9A to 9C are example views illustrating an arrangement of a sensor according to an example of the disclosure.

FIG. 10 is an example view illustrating a door control module of a refrigerator according to an example of the disclosure.

FIGS. 11A and 11B illustrate an automatic door opening method of a refrigerator according to an example.

FIGS. 12A and 12B illustrate an automatic door opening method of a refrigerator according to an example.

FIGS. 13A and 13B illustrate an automatic door opening method of a refrigerator according to an example.

FIG. 14 is a flowchart illustrating an operation of a refrigerator according to an example of the disclosure.

### MODE FOR THE INVENTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that when an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The term “and/or” may denote a combination(s) of a plurality of related components as listed or any of the components.

Functions related to artificial intelligence (AI) according to the disclosure are operated through a processor and a memory. The processor may be composed of one or more processors. In this case, the one or more processors may be a general-purpose processor such as a central processing unit (CPU), an application processor (AP), a digital signal processor (DSP), a graphics-dedicated processor such as a graphics processing unit (GPU) or a vision processing unit (VPU), or an artificial intelligence-dedicated processor such as a neural processing unit (NPU). The one or more processors control to process input data according to predefined operation rules or artificial intelligence models stored in the memory. Alternatively, in case that the one or more processors are AI-dedicated processors, the AI-dedicated processors may be designed with a hardware structure specialized for processing a specific AI model. The processor may perform a preprocessing process that converts data to be applied to the artificial intelligence model into a form suitable for application to the artificial intelligence model.

The artificial intelligence (AI) model may be created via training. Here, “created by training” means that a predefined operation rule or artificial intelligence model configured to achieve a desired feature (or goal) is created by training a basic artificial intelligence model with multiple pieces of training data and a training algorithm. Such learning may be performed in the device itself where artificial intelligence according to the disclosure is performed, or may be performed through a separate server and/or system. Learning algorithms may include, but are not limited to, e.g., supervised learning, unsupervised learning, semi-supervised learning, or reinforcement learning.

The artificial intelligence model may include a plurality of neural network layers. Each of the plurality of neural network layers includes a plurality of weight values and performs neural network computation by computation between the result of computation by a previous layer and the plurality of weight values. The plurality of weights possessed by the plurality of neural network layers may be optimized by the training results of the artificial intelligence model. For example, the plurality of weights may be updated so that the loss value or cost value obtained from the artificial intelligence model is reduced or minimized during the learning process. The artificial neural network may include a deep neural network (DNN), such as a convolutional neural network (CNN), a deep neural network (DNN), a recurrent neural network (RNN), a limited Boltzmann machine (RBM), a deep belief network (DBN), a bidirectional recurrent deep neural network (BRDNN) or deep Q-networks, but is not limited to the above-described examples.

Artificial intelligence models used in examples of the disclosure may be implemented in various embodiments according to a manufacturer of an electronic device or a user of the electronic device, and are not limited by the examples.

Hereinafter, the working principle and examples of the disclosure are described with reference to the accompanying drawings.

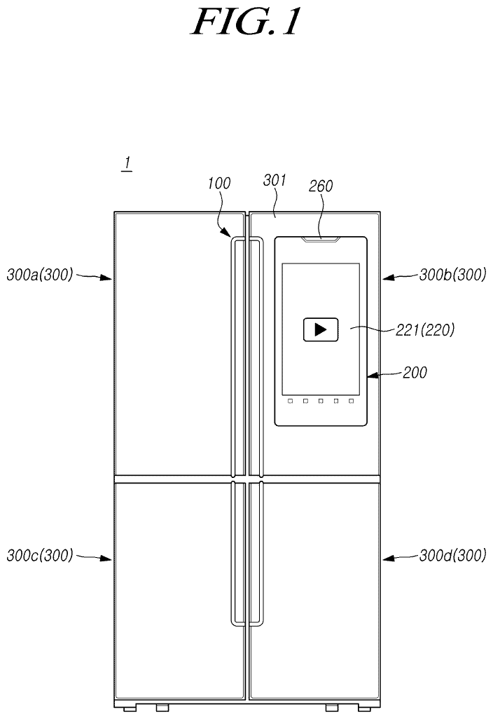

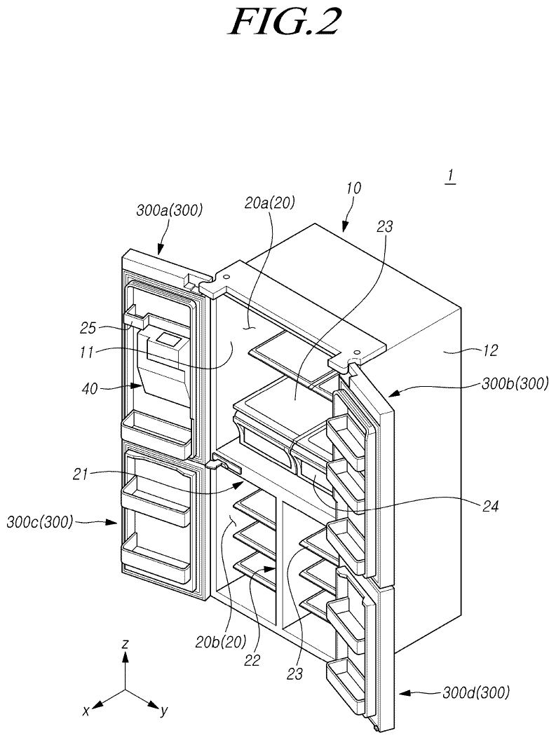

FIG. 1 is a front view illustrating a refrigerator 1 according to an embodiment of the disclosure, and FIG. 2 is a perspective view illustrating an inside of a refrigerator 1 according to an embodiment of the disclosure.

The refrigerator 1 may include a main body 10, a storage compartment 20 provided inside the main body 10 to have an open front surface, and a door 300 rotatably coupled to the main body 10 to open and close the open front surface of the storage compartment 20.

The main body 10 may form an outer appearance of the refrigerator 1. The main body 10 may include an inner case 11 forming a storage compartment 20, and an outer case 12 coupled to the outside of the inner case 11 to form an outer appearance. Further, the main body 10 may further include a cold air supply device (not shown) for supplying cold air to the storage compartment.

The cold air supply device may include components such as a compressor, a condenser, an expansion valve, an evaporator, a blower fan, a cold air duct, or the like. An insulation material (not shown) may fill between the inner case 11 and the outer case 12 of the main body 10 to prevent cold air from leaking out of the storage compartment.

A machine (not shown) in which a compressor for compressing the refrigerant and a condenser for condensing the compressed refrigerant are installed may be provided on a lower rear side of the main body 10.

The storage compartment may be divided into a plurality of ones by a horizontal partition wall 21 and a vertical partition wall 22. In the present embodiment, the storage compartment may include an upper storage compartment 20a and a lower storage compartment 20b. In the storage compartment, a shelf 23 on which food may be placed and a sealed container 24 for hermetically storing food may be provided. The storage compartment is provided to have an open front surface so that food may be taken in and out, and the open front surface may be opened and closed by the door 300.

The upper storage compartment 20a may be opened and closed by a plurality of doors 300a and 300b. The lower storage compartment 20b may be opened and closed by a plurality of doors 300c and 300d.

The refrigerator 1 may further include a handle 100 provided on the door 300. The user may easily open and close the door 300 by holding the handle 100. The handle 100 may be elongated along the vertical direction Z of the door 300.

The refrigerator 1 may further include a dispenser (not shown). The dispenser may be installed in the door 300. In an embodiment, the dispenser may be installed in the left upper door 300a. Through the dispenser, the user may directly dispense water or ice to the outside without opening the door 300a. The dispenser may include a cavity recessed inward of the door 300a to form a dispensing space. The cavity may be provided with an outlet through which water or ice is dispensed, and an dispensing lever by which water or ice is dispensed. In case that the dispensing lever is pressurized, water or ice is dispensed from the outlet. The dispenser may further include a dispenser status display window for displaying the operation state of the dispenser. The dispenser status display window may have a touch function.

In an embodiment, the refrigerator 1 may further include a display 200.

The display 200 may be installed on the door 300 for the user's convenience. Specifically, the display 200 may be installed on the front surface 301 of the door 300.

Hereinafter, a case where the display 200 is installed on the right upper door 300b is illustrated, but the position where the display 200 may be installed is not limited to the right upper door 300b as long as installed on the door 300. However, the following description focuses primarily on a case where the display 200 is installed on the right upper door 300b.

The upper end portion of the display 200 may be placed at the same position as the upper end portion of the handle 100 in the vertical direction Z of the door 300.

The lower end portion of the display 200 may be positioned at the same position as the lower end portion of the dispenser 40 in the vertical direction Z of the door 300. One side end portion of the display 200 adjacent to the handle 100 may be spaced apart from the handle 100 by a predetermined interval. The other side end portion, facing the one side end portion, of the display 200 adjacent to the handle 100 may be spaced apart from the edge of the door 300 by a predetermined interval.

In another aspect, the display 200 may have a rectangular shape having the longer side in the vertical direction Z of the door 300. The display 200 may include a right longer side facing the right side of the door 300, a left longer side facing the left side of the door 300, an upper shorter side facing the upper side of the door 300, and a lower shorter side facing the lower side of the door 300.

The right longer side may be spaced apart from the right edge of the door 300 by a predetermined interval in the left direction of the door 300. The left longer side may be spaced apart from the handle 100 by a predetermined interval in the right direction of the door 300. The upper shorter side may be positioned at the same position as the upper end portion of the handle 100 in the vertical direction Z of the door 300. The lower shorter side may be positioned at the same position as the lower end portion of the dispenser 40 in the vertical direction Z of the door 300.

Through the arrangement of the display 200, it is possible to implement a neat and stable design of the refrigerator 1.

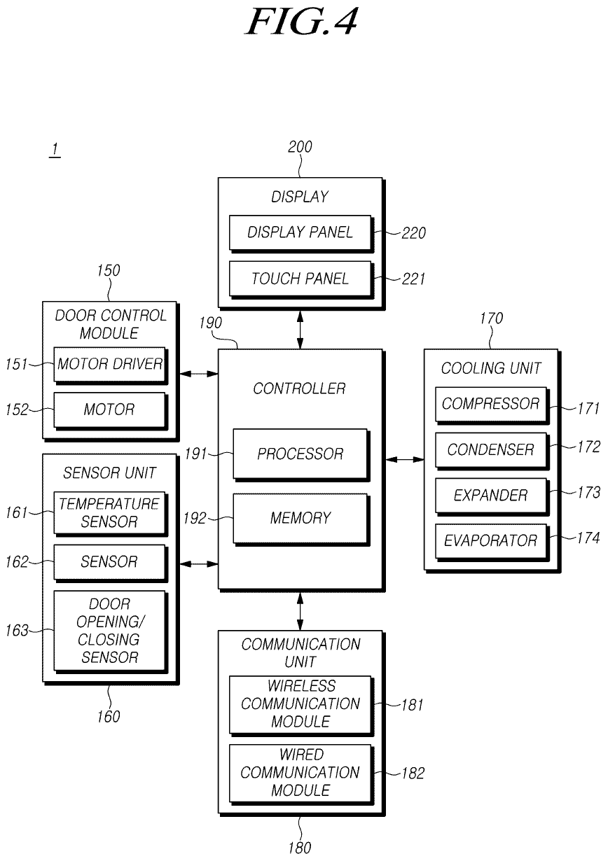

The display 200 may include a display panel 220 and a touch panel 221. However, the display 200 may include only the display panel 220. The display 200 may have a wake-up function that is automatically activated in case that the user approaches within a predetermined range. For example, the wake-up function may be implemented through a sensor (e.g., the sensor 162 of FIG. 4).

Specifically, in case that the sensor 162 detects the user's approach within a predetermined range, the display 200 may be activated. In other words, the display 200 may be turned on. Conversely, in case that the sensor 162 does not detect the user's approach within the predetermined range, the display 200 may not be activated. In other words, the display 200 may be maintained in an off state. In case that the display 200 is activated, various videos or images may be displayed on the display 200.

For example, the display 200 may have a function of pausing video playback and turning off the power of the display 200 in case that the user opens the door equipped with the display 200. Further, the display 200 may have a function of resuming video playback and turning on the power of the display 200 in case that the user closes the door equipped with the display 200. For example, the power-off/on function of the display 200 may be implemented through a door opening/closing sensor (e.g., the opening/closing sensor 163 of FIG. 4).

The display 200 may include a display panel 220. The display 200 may include a liquid crystal display (LCD). The display panel 220 may be positioned on the front surface of the display. The touch panel 221 may be formed on the display panel 220.

The user may play or pause video by touching the touch panel 221. The touch panel 221 may be implemented in a capacitive type or a resistive type. However, the method for forming the touch panel 221 is not limited to the above-described example.

At least one input user interface (UI) component may be provided on the display panel 220. The at least one input UI component may include, e.g., a camera UI component executing a camera (e.g., the sensor 162 of FIG. 4), a list UI component listing various lists related to the function of the refrigerator 1, a home UI component returning to the start screen, a return UI component returning to the pre-execution stage, an information providing UI component providing information about the overall function of the refrigerator 1 or the overall function of the display 200, or the like.

At least one input UI component may be formed on the display panel 220. Preferably, at least one input UI component may be formed in an outer area of the display panel 220 so as not to interfere with an image or video displayed on the display 200.

The refrigerator 1 may further include at least one microphone for implementing a voice recognition function. A voice command input through at least one microphone is transferred to a processor (e.g., the processor 191 of FIG. 4), and the processor 191 controls the display 200 to display a voice command result.

The refrigerator 1 may further include an illuminance sensor. The illuminance sensor may adjust the lighting of the display to be brighter in a bright place and adjust the lighting of the display to be darker in a dark place to reduce the power consumption of the refrigerator 1. The detection result of the illuminance sensor is transferred to the processor 191, and the processor 191 controls the display panel 220 to adjust the illuminance of the display 200.

The refrigerator 1 may include a door opening/closing sensor 163. The door opening/closing sensor 163 may be provided on a hinge (not shown) that couples the door 300 with the main body 10, or may be provided on a portion of the door 300 where the door 300 and the main body 10 contact.

At least one of the sensor 162, at least one microphone, and the illumination sensor may be disposed on the front surface of the door 300. For example, at least one of the sensor 162, at least one microphone, and the illuminance sensor may detect a change in the front X of the refrigerator 1.

At least one of the sensor 162, at least one microphone, and the illumination sensor may be disposed on the rear surface of the door 300. For example, at least one of the sensor 162, at least one microphone, and the illuminance sensor may detect a change in the inside (e.g., the storage compartment 20) of the refrigerator 1.

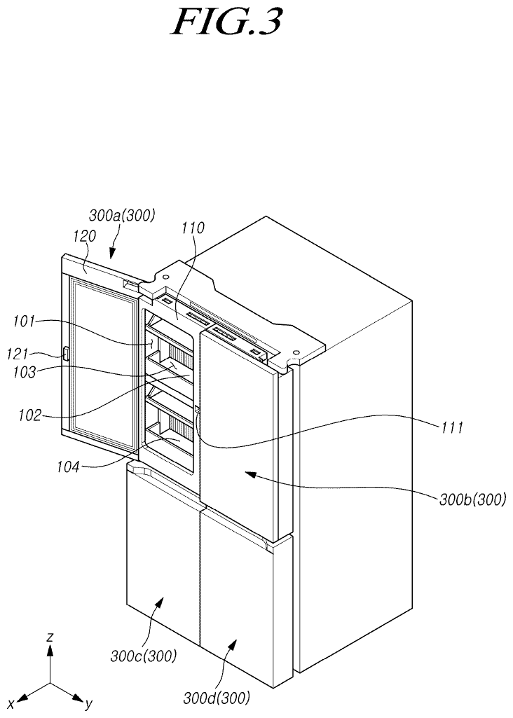

FIG. 3 is a perspective view illustrating an outer door 120 opened in a refrigerator 1 according to an example.

The refrigerator 1 may include at least one door 300. At least one of the doors 300 may be configured as a dual door having an inner door 110 and an outer door 120. In an embodiment, the left upper door 300a may include an inner door 110 and an outer door 120.

The inner door 110 may be rotatably coupled to the main body 10 through a hinge. The inner door 110 may have an opening 101. The opening 101 may be formed in a central portion except for an edge portion of the inner door 110.

At least one door basket 102; 104 may be mounted in an opening 101. A portion of the door basket 102; 104 may be disposed on a rear side of an inner door 110.

An outer door 120 may be provided to open and close the opening 101 of the inner door 110. In case that the outer door 120 is opened, the opening 101 of the inner door 110 may be accessed. The outer door 120 may be rotatably coupled to the inner door 110 through a hinge. The outer door 120 may rotate in the same direction as the inner door 110.

The outer door 120 may be opaque. However, the outer door 120 is not limited thereto. For example, the outer door 120 may be a transparent door that is partially transparent. Accordingly, a rear side of the outer door 120 may be visible without opening the outer door 120. For example, the opening 101 of the inner door 110 may be visible.

The outer door 120 may have a size corresponding to the size of the inner door 110. The outer door 120 may cover an entire area of the inner door 110. However, the size of the outer door 120 is not limited thereto and may be smaller than the size of the inner door 110.

A latch 121 for fixing with the inner door 110 may be provided on the outer door 120, and a catch 111 may be provided on the inner door 110 to engage with the latch 121.

In case that the outer door 120 is opened with the latch 121 and the catch 111 engaged, the outer door 120 and the inner door 110 open together and, in case that the outer door 120 is opened with the latch 121 and the catch 111 not engaged, only the outer door 120 opens and the inner door 110 may not open.

A decorative panel (not illustrated) may be detachably coupled to a front surface of the outer door 120.

A door 300 of a refrigerator 1 according to an example may further include a door inner space 103 formed on a rear side of the inner door 110. The door inner space 103 may be a space independent from a storage compartment 20 so that food may be stored separately from the storage compartment 20. The door inner space 103 may have a different temperature from the storage compartment 20.

The refrigerator 1 may include a door control module for controlling opening or closing of the inner door 110. The refrigerator 1 may include a door control module for controlling opening or closing of the outer door 120.

FIG. 4 is a block diagram illustrating a configuration of a refrigerator 1 according to an example of the disclosure.

Referring to FIG. 4, the refrigerator 1 may include a door control module 150, a sensor unit 160, a cooling unit 170, a communication unit 180, a controller 190, and a display 200.

The door control module 150 may control opening or closing of at least one door. The door control module 150 may include a motor driver 151 and a motor 152. For example, the door control module 150 may precisely control the movement of at least one door 300 according to whether at least one door 300 is opened or the degree of opening.

The motor driver 151 may control the motor. For example, the motor driver 151 may activate or deactivate the motor 152. For example, the motor driver 151 may control the operation state of the motor 152 by supplying or cutting off power to the motor 152.

The motor 152 may open at least one door by rotating. For example, the motor 152 may be activated based on the control of the motor driver, thereby opening at least one door. For example, the motor 152 may be deactivated based on the control of the motor driver, thereby closing at least one door.

The sensor unit 160 may include a temperature sensor 161, a sensor 162, and a door opening/closing sensor 163.

The temperature sensor 161 may sense the temperature around the refrigerator 1 or inside the refrigerator 1. For example, the temperature sensor 161 may include a plurality of temperature sensors for sensing the temperature inside the storage compartment 20. For example, the temperature sensor 161 may include a plurality of temperature sensors for sensing the external temperature around the refrigerator 1.

For example, the plurality of temperature sensors may be installed in the plurality of storage compartments 20, respectively, to sense the temperature of each of the plurality of storage compartments 20 and output an electrical signal corresponding to the sensed temperature to the controller 190. Each of the plurality of temperature sensors may include a thermistor whose electrical resistance changes according to temperature.

A sensor 162 is a component for sensing various information, e.g., point cloud data. For example, the sensor 162 may include at least one of a radio detection and ranging (radar) sensor, an optical sensor, or an ultrasonic sensor. In an embodiment, the sensor 162 may be a radar sensor.

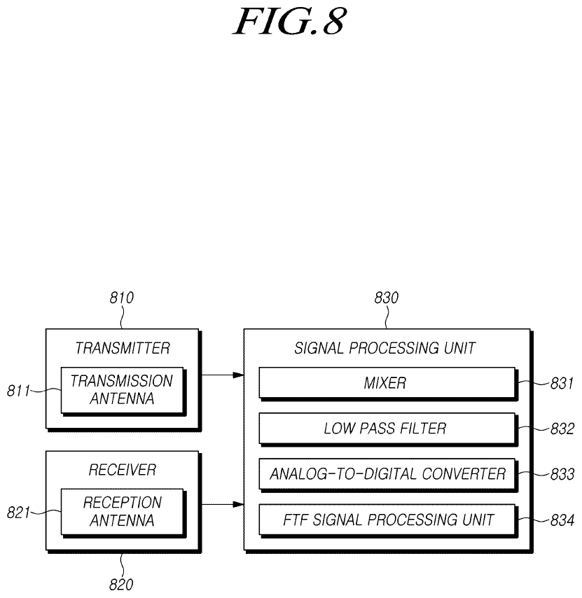

A radar sensor may generate a point cloud by transmitting electromagnetic waves (radio waves) and measuring the time it takes for the electromagnetic waves to be reflected from an object and return. The wavelength of electromagnetic waves used by a radar sensor mainly belongs to a microwave or millimeter wave band. For example, a microwave radar may use a wavelength of 10 mm to 300 mm. For example, a millimeter wave radar may use a wavelength of 1 mm to 10 mm. The longer the wavelength, the more advantageous long-distance detection may be (e.g., microwave band). The shorter the wavelength, the more precise detection (e.g., small object detection) may be possible (e.g., millimeter wave band). For example, a sensing distance using a radar sensor may be within 8 m or 1 to 3 m. A radar sensor may have a field of view (FoV). The field of view of a radar sensor may include a horizontal FoV and a vertical FoV. A horizontal field of view is a range in which a radar sensor may sense in a horizontal direction. For example, a horizontal field of view may be 60 degrees. A vertical field of view is a range in which a radar sensor may sense in a vertical direction. For example, a vertical field of view may be 40 degrees. A radar sensor may detect an object within a predetermined distance from the radar sensor. A configuration of a radar sensor is described later with reference to FIG. 8.

An optical sensor may include at least one of a light detection and ranging (LiDAR) sensor, a structured light sensor, a laser scanner, or a camera sensor. A LiDAR sensor may generate a point cloud by transmitting high-energy laser pulses and measuring the time it takes for the laser pulses to be reflected from an object and return. A structured light sensor may generate a point cloud by projecting a pattern onto an object using a camera and a projector, and analyzing how the pattern is distorted on the surface of the object. A laser scanner may generate a point cloud by scanning the surface of an object using a laser beam and measuring distance through reflected light. A camera sensor may be a sensor that generates a digital image by converting light collected in a sensing area into an electrical signal. For example, a camera sensor may include at least one of a time of flight (ToF) sensor, a stereo camera, or an RGB-D (RGB-Depth) camera. A ToF sensor may transmit light to an object and measure the return time of reflected light. An RGB-D camera is a device that combines an RGB camera and a depth sensor, and may measure depth information while capturing a 2D image. A stereo camera may include two or more cameras. A stereo camera may estimate the depth of each pixel using disparity between images obtained using two or more cameras, and may generate a 3D point cloud through this.

An ultrasonic sensor may generate a point cloud by transmitting ultrasonic waves and measuring the time it takes for the ultrasonic waves to be reflected from an object and return.

As described above, the door opening/closing sensor 163 may output whether the door 300 is opened or closed as a preset determination value. For example, the door opening/closing sensor 163 may output 1 in case that the door 300 is open, and 0 in case that the door 300 is closed.

The door opening/closing sensor 163 may also be implemented as a distance sensor and, in case that the distance between the door 300 and the main body is more than a reference distance, it may determine that the door 300 is open and, in case that the distance is less than the reference distance, determine that the door 300 is closed. However, the door opening/closing sensor 163 is not limited thereto, and its configuration is not particularly limited as long as it may determine whether the door 300 is open and output a preset determination value accordingly.

The cooling unit 170 may supply cooled air to the storage compartment. Specifically, the cooling unit 170 may maintain the temperature of the storage compartment within a range designated by the user using the circulation of the refrigerant in the refrigerant circuit.

The cooling unit 170 may include a compressor 171 for compressing the gaseous refrigerant, a condenser 172 for converting the compressed gaseous refrigerant into a liquid state, an expander 173 for decompressing the liquid refrigerant, and an evaporator 174 for converting the decompressed liquid refrigerant into a gaseous state. The cooling unit 170 may cool the air in the storage compartment using the phenomenon in which the liquid refrigerant absorbs thermal energy of the surrounding air while converting to the gaseous state.

However, the cooling unit 170 is not limited as including a refrigerant circuit. For example, the cooling unit 170 may include a Peltier element using the Peltier effect or a magnetic cooling material using a magnetic thermal effect.

The communication unit 180 may exchange data with external devices such as a server device and/or a user device and/or a cooking device.

The communication unit 180 may include a wired communication module 182 for wiredly exchanging data with external devices and a wireless communication module 181 for wirelessly exchanging data with external devices.

The wired communication module 182 may access a wired communication network and communicate with external devices through the wired communication network. For example, the wired communication module 182 may access the wired communication network through Ethernet (Ethernet, IEEE 802.3 technology standard) and receive data from the external devices through the wired communication network.

The wireless communication module 181 may wirelessly communicate with a base station or an access point (AP), and may access the wired communication network through the base station or the access point. The wireless communication module 181 may also communicate with the external devices connected to the wired communication network via the base station or the access point. For example, the wireless communication module 181 may wirelessly communicate with the access point (AP) using Wi-Fi (IEEE 802.11 technology standard), or communicate with the base station using CDMA, WCDMA, GSM, long term evolution (LTE), or Wi-Bro. The wireless communication module 181 may also receive data from the external devices via the base station or the access point. Further, the wireless communication module 181 may directly communicate with the external devices. For example, the wireless communication module 181 may receive data wirelessly from the external devices using Wi-Fi, Bluetooth (IEEE 802.15.1 technology standard), ZigBee (IEEE 802.15.4 technology standard), etc.

As such, the communication unit 180 may transmit or receive data with the external devices, and in particular, may receive video data including video and/or audio from the external devices and output the received data to the controller 190.

The controller 190 may process user input and/or door opening/closing detection data and/or communication data, and control the components included in the refrigerator 1 based on data processing.

The controller 190 includes a memory 192 that stores/records programs and/or data, and a processor 191 that processes user input and/or door opening/closing detection data and/or communication data according to the program and/or data stored in the memory 192.

The memory 192 may store/memory a program and/or data. The program includes a plurality of instructions combined to perform a specific function, and the data may be processed and/or treated by a plurality of instructions included in the program. Further, the program and/or data may include system programs and/or system data directly related to the operation of the refrigerator 1, and application programs and/or application data that provide convenience to the user.

The memory 192 may include a non-volatile memory storing a program and/or data for controlling the components included in the refrigerator 1 and a volatile memory storing temporary data generated during controlling the components included in the refrigerator 1.

The non-volatile memory may store programs and/or data, e.g., electrically, magnetically or optically. The non-volatile memory may include, e.g., a read only memory or flash memory for storing data for a long time. The non-volatile memory may also include a solid state drive (SSD), a hard disk drive (HDD), or an optical disc drive (ODD).

The volatile memory may load the program and/or data from the non-volatile memory, e.g., and may electrically store the program and/or data. The volatile memory may include, e.g., static random access memory (S-RAM) and/or dynamic random access memory (D-RAM) for temporarily storing data.

The memory 192 may store/record programs and data such as operating systems (OS), middleware, and applications, and may provide the programs and data to the processor 191 in response to a request of the processor 191.

The processor 191 may process a user input of the display 200 and detection data of the sensor 162 and/or communication data of the communication unit 180 according to the program and/or data stored/recorded in the memory 192. Further, the processor 191 may generate a control signal for controlling the operation of the display 200, and/or communication unit 180 based on data processing.

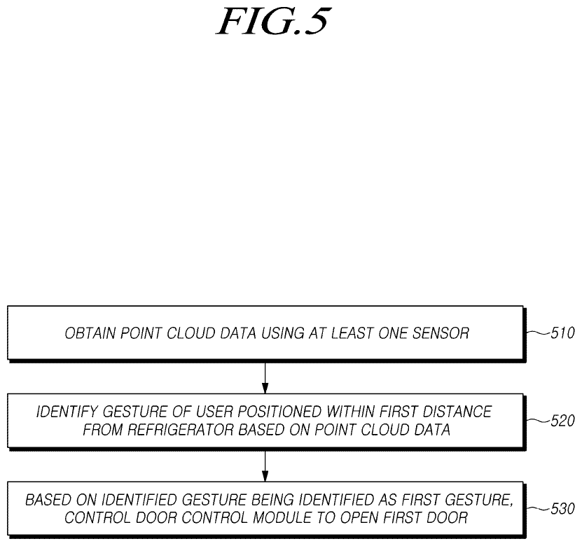

FIG. 5 is a flowchart illustrating an operation of a refrigerator 1 according to an example of the disclosure.

In the following operation examples, each operation may be sequentially performed, but is not necessarily performed sequentially. For example, the order of each operation may be changed, or at least two operations may be performed in parallel. At least some of the operations may be performed on a server.

Referring to FIG. 5, the refrigerator 1 of the disclosure may obtain point cloud data corresponding to a user using at least one sensor, and automatically open a door by identifying a gesture of the user instructing door opening from the point cloud data.

According to an embodiment, the refrigerator 1 may obtain point cloud data using at least one sensor (e.g., the sensor 162 of FIG. 4) (operation 510), identify a gesture of a user positioned within a first distance from the refrigerator based on the point cloud data (operation 520), and control a door control module (e.g., the door control module 150 of FIG. 4) to open a first door based on the identified gesture being identified as a first gesture (operation 530).

According to an embodiment, the refrigerator 1 may obtain point cloud data using the sensor 162 in operation 510. The sensor 162 may include various sensors capable of obtaining point cloud data. The point cloud data may include a point cloud included in a frame captured by the sensor 162 at a specific time. For example, the sensor 162 performs dozens or hundreds of scans per second, and the scanned information may be obtained as a frame at a specific time. The frame may include a point cloud corresponding to an object (e.g., a person, an animal) included in the sensing range of the sensor 162. The point cloud may be a set of individual points having coordinate values in 3D. Each of a plurality of points included in the point cloud may include coordinate values of x-axis, y-axis, and z-axis. The refrigerator 1 may obtain a plurality of points corresponding to an object included in the sensing range (or field of view) of the sensor 162. The plurality of points included in the point cloud correspond to the object included in the sensing range of the sensor 162. The refrigerator 1 may obtain a plurality of frames including a point cloud. Each frame may include a point cloud along with time information. The refrigerator 1 may obtain point cloud data based on frames obtained by the sensor 162 during a predetermined time period. The point cloud data may include a point cloud included in frames captured by the sensor 162 during a certain time period.

According to an embodiment, the refrigerator 1 may identify a gesture of a user positioned within a first distance from the refrigerator based on the point cloud data in operation 520. The first distance may be determined according to the sensing range of the sensor 162. The first distance may be a distance between an object included in the sensing range of the sensor 162 and the refrigerator. The refrigerator 1 may identify a gesture of a user included in the sensing range of the sensor 162. The refrigerator 1 may identify a gesture of a user positioned within the field of view (FoV) of the sensor 162. The refrigerator 1 may identify a gesture of a user positioned in a front direction of the refrigerator 1 (a direction looking outward from the door of the refrigerator 1). The refrigerator 1 may identify a gesture of the user after identifying that the user is positioned within the first distance for at least a designated time based on the point cloud data. The refrigerator 1 may cluster a plurality of points included in the point cloud. The refrigerator 1 may analyze and classify an object based on the clustered point cloud. The refrigerator 1 may identify an object (e.g., a person) through clustering. For example, the refrigerator 1 may identify a person. In case of identifying a person, the refrigerator 1 may cluster a plurality of points corresponding to major body joints of the person and extract a skeleton based on the clustered points. The refrigerator 1 may track movement of the skeleton. The movement of the skeleton may include the movement of the skeleton (e.g., position changes of major body joints) during a specific time period, and a specific posture (pose) taken by the skeleton and a transformation of the pose. The refrigerator 1 may identify a gesture of a person based on the tracked movement of the skeleton. The refrigerator 1 may identify a gesture of a person using an artificial intelligence model. For example, the refrigerator 1 may infer an intended gesture from the point cloud data using an artificial intelligence model trained to identify a gesture of the user. The intended gesture may be a gesture implemented by a user through body movement or body pose. For example, an intended gesture may be a gesture actually performed by a user to provide a preset gesture (e.g., a first gesture) to the refrigerator 1. The refrigerator 1 may infer a gesture (e.g., a first gesture) that the user intends to provide based on the point cloud data.

According to an embodiment, the refrigerator 1 may control the door control module to open a first door based on the identified gesture being identified as a first gesture in operation 530. The first door may be selected from among at least one door included in the refrigerator 1. The first door may be one or more doors. The refrigerator 1 may comprise at least one door (e.g., one, two, three, or four), and the first door may be one or more of the at least one door. The first gesture may be a preset gesture for opening the first door. The first gesture may include a pose or movement. For example, the first gesture may be a finger spreading pose in which the user spreads the palm and spreads the fingers away from each other. For example, the first gesture may be a gesture in which the user raises the hand from bottom to top by 50 cm or more. The refrigerator 1 may add or change the first gesture according to a user input. For example, the refrigerator 1 may add a gesture of shaking the head side to side, a gesture of clapping, or a gesture of moving the foot according to a user input. The refrigerator 1 may recognize a command to open the first door from the first gesture. In an embodiment, the first door may be a preset door. The refrigerator 1 may set the first door as a specific door. For example, the refrigerator 1 may set the first door as an upper door. For example, the refrigerator 1 may set the first door as a lower door. The refrigerator 1 may be designed so that only a preset first door (e.g., an upper door) automatically opens in response to the first gesture. In an embodiment, the refrigerator 1 may select the first door to be opened in response to the first gesture according to a user input. For example, the refrigerator 1 may map the first door to be opened in response to the first gesture to a specific door according to a user input. In response to the first gesture, the refrigerator 1 may open the first door mapped to the first gesture. The refrigerator 1 may provide a user interface for selecting the first door to be opened in response to the first gesture. For example, the user interface may be provided through a display (e.g., the display 200 of FIG. 4) of the refrigerator 1. For example, the user interface may be provided through a server and/or device connected to the refrigerator 1. The refrigerator 1 may control the door control module to open the first door. For example, the door control module 150 may automatically open the first door using rotational force of a motor.

According to an embodiment, the refrigerator 1 may identify a second gesture of a user located within a first distance from the refrigerator 1 based on cloud point data obtained using at least one sensor, and perform control to open a second door based on the second gesture being identified. The second gesture may be different from the first gesture. The second door may be one or more of at least one door, and may be different from the first door.

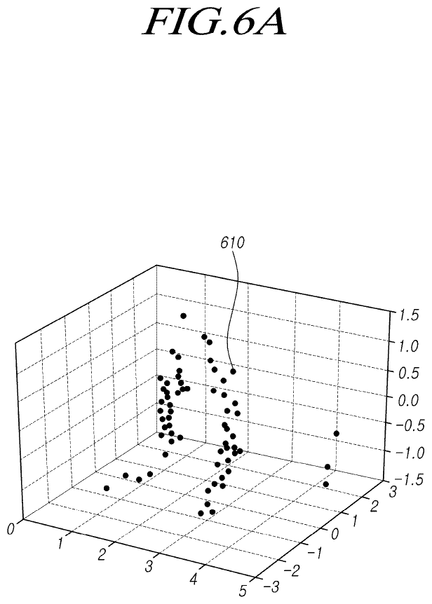

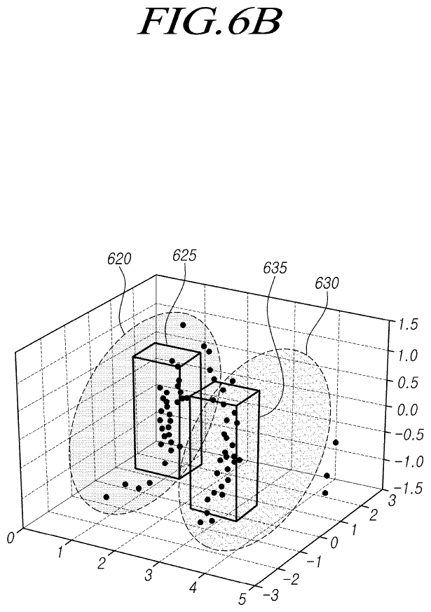

FIGS. 6A and 6B illustrate an example method of obtaining and processing point cloud data.

In FIG. 6A, the refrigerator 1 may obtain (or generate) point cloud data based on sensing data obtained by the sensor 162. The refrigerator 1 may process the sensing data to obtain point cloud data. For example, the refrigerator 1 may remove noise and/or filter the sensing data. The refrigerator 1 may extract information such as distance and/or angle between an object in a scene and the sensor based on the sensing data. The refrigerator 1 may convert the extracted information into point cloud data including points 610 in a three-dimensional coordinate system.

The sensor 162 may include a sensor that measures a depth value of an object. For example, the sensor 162 may include at least one of a radar sensor, an optical sensor, or an ultrasonic sensor. For example, an optical sensor may include at least one of a LiDAR sensor, an RGB-D sensor, a depth sensor, or a ToF sensor. The sensor 162 may obtain sensing data including a depth value. The refrigerator 1 may obtain point cloud data based on the sensing data.

According to an example, the sensor 162 may include a radar sensor. The sensor 162 may transmit electromagnetic waves to an object and receive reflected signals to obtain at least one of distance, direction, or speed with the object. The sensor 162 may obtain 3D position information of the object by combining at least one of distance, direction, or speed with the object.

According to an embodiment, the sensor 162 may include an image sensor (e.g., an RGB sensor). The sensor 162 may obtain sensing data (e.g., a color image) corresponding to an object. The refrigerator 1 may estimate the depth of a scene (or object) from 2D sensing data to obtain point cloud data based on the sensing data. For example, the refrigerator 1 may estimate the depth of a scene using a visual simultaneous localization and mapping (vSLAM) algorithm. The refrigerator 1 may obtain point cloud data using the sensing data and the estimated depth.

According to an embodiment, the sensor 162 may include a stereo camera (e.g., two image sensors). For example, two image sensors may be disposed in the refrigerator 1 at regular intervals. Each of the two image sensors may capture an object at the same time. Each of the two image sensors may obtain a color image corresponding to the object. The refrigerator 1 may estimate the depth of a scene from two color images. The refrigerator 1 may generate a point cloud using the sensing data and the estimated depth.

According to an embodiment, the sensor 162 may be composed of a combination of two or more types of sensors. The refrigerator 1 may time-synchronize sensing data obtained by two or more types of sensors. In an example, the sensor 162 may be composed of an image sensor and a ToF sensor. The refrigerator 1 may generate a point cloud using a color image obtained by the image sensor and a depth value obtained by the ToF sensor. In an example, the sensor 162 may be composed of an RGB-D sensor and a LiDAR sensor. The refrigerator 1 may generate a point cloud based on sensing data obtained by each of the RGB-D sensor and the LiDAR sensor. According to an example, using more types of sensors, a point cloud with high accuracy may be generated.

According to an embodiment, in case that the sensing data is a plurality of still images (e.g., frames), the refrigerator 1 may align point clouds corresponding to various positions and angles using a plurality of frames of the plurality of still images.

In FIG. 6B, the refrigerator 1 may process point cloud data. In an embodiment the refrigerator 1 may perform single frame processing. For example, the refrigerator 1 may cluster a point cloud included in one frame obtained at a specific time. The refrigerator 1 may obtain point cloud data and identify information such as position, size, or shape of at least one object in a space through clustering. Each cluster may correspond to an object (e.g., a person, an animal) in the point cloud. For example, the refrigerator 1 may cluster spatially dense points using a density-based spatial clustering of application with noise (DBSCAN) algorithm. The refrigerator 1 may include points with similar movement tendencies (speed and/or direction) in a cluster and remove points with dissimilar movement tendencies (e.g., noise) from the cluster. For example, the refrigerator 1 may cluster a point cloud using an artificial intelligence model (e.g., DeepCluster). For example, as illustrated in FIG. 6B, the refrigerator 1 may detect a plurality of objects by clustering a point cloud. For example, the point cloud may include a first cluster 620 and a second cluster 630. The refrigerator 1 may generate a three-dimensional bounding box 625, 635 corresponding to each of the detected plurality of clusters 620, 630. The three-dimensional bounding box 625, 635 has a rectangular parallelepiped shape and may include information such as a center point (x, y, z) or size (width, height, depth). Hereinafter, “three-dimensional bounding box” may be referred to as “bounding box.” According to an embodiment, the refrigerator 1 may manually generate the bounding box 625, 635 using a labeling tool. According to an embodiment, the refrigerator 1 may automatically generate the bounding box 625, 635 using a clustering algorithm. The bounding box 625, 635 may define an area where an object is present and provide the position and size of the object. The bounding box 625, 635 may be used for at least one of object detection, object classification, tracking, or skeleton analysis. The refrigerator 1 may detect a specific object (e.g., a person, an animal) using the bounding box 625, 635. The refrigerator 1 may classify an object inside the bounding box 625, 635 into a specific class (e.g., cat, dog). The refrigerator 1 may continuously detect a specific object in frames using the bounding box 625, 635 to track a movement path. The refrigerator 1 may detect an approximate position of an object (e.g., a person) using the bounding box 625, 635, and then perform detailed skeleton extraction.

In an example, the refrigerator 1 may perform sequential frames processing. The refrigerator 1 may track a cluster based on a plurality of frames. The refrigerator 1 may identify whether the cluster corresponds to a moving object. The refrigerator 1 may measure a median speed of the cluster. The median speed of the cluster may be a median value of speeds of all points belonging to the cluster. The refrigerator 1 may identify as a moving object in case that the median speed of the cluster exceeds a threshold. The refrigerator 1 may identify as a stationary object in case that the median speed is below the threshold. The refrigerator 1 may track each of a plurality of clusters. The refrigerator 1 may distinguish between moving objects and stationary objects, and track each cluster corresponding to moving objects and stationary objects.

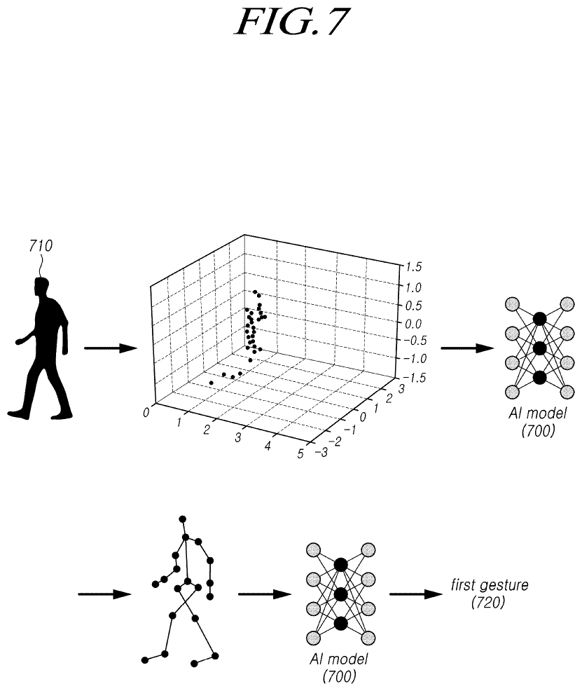

FIG. 7 is a view illustrating a process in which a refrigerator determines a gesture 710 of a user from point cloud data using an artificial intelligence model 700 according to an example of the disclosure.

Referring to FIG. 7, the refrigerator 1 may determine a user's intention (e.g., door opening intention or door closing intention) from point cloud data using the artificial intelligence model 700. For example, the refrigerator 1 may determine the user's intention by inferring an intended gesture 710 of the user from the point cloud data using the artificial intelligence model 700 that has learned a correlation between point cloud data and preset gestures.

The intended gesture 710 may be a gesture implemented by a user through body movement or body pose. For example, the intended gesture 710 may be a gesture actually performed by a user to provide a preset gesture (e.g., a first gesture 720) to the refrigerator 1. The refrigerator 1 may infer the intended gesture 710 from the point cloud data and determine a gesture (e.g., the first gesture 720) that the user intends to provide from the intended gesture 710.

The artificial intelligence model 700 used by the refrigerator 1 for inference of the intended gesture 710 may be one artificial intelligence model or may be implemented as a plurality of artificial intelligence models. The artificial intelligence model 700 may include neural networks (or artificial neural networks), and may include a statistical learning algorithm that mimics the nerves of biology in machine learning and cognitive science. The neural network may refer to all types of models which have problem-solving ability as artificial neurons (nodes) forming a network through synaptic bonding change the strength of synaptic bonding through learning. The neuron in the neural network may include a combination of weights or biases. The neural network may include one or more layers composed of one or more neurons or nodes. For example, the neural network may include an input layer, a hidden layer, and an output layer. The neural network may infer an output to be predicted from an arbitrary input by changing the weight of the neuron through learning.

At least one processor included in the refrigerator 1 may generate a neural network, train or learn the neural network, perform a calculation based on received input data, generate an information signal based on the performance result, or retrain the neural network. For example, the neural network may include a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN), but is not limited thereto. The at least one processor included in the refrigerator 1 may include one or more processors for performing calculation according to the models of the neural network.

According to an embodiment, the refrigerator 1 may identify an object (e.g., a person) from the point cloud data and track movement of the identified object. The refrigerator 1 may identify a gesture based on the tracked movement of the object. The refrigerator 1 may determine whether the identified gesture is the first gesture 720.

According to an embodiment, the refrigerator 1 may recognize an object belonging to a space according to analysis and classification of the object. The refrigerator 1 may use the artificial intelligence model 700 to recognize the object. The artificial intelligence model 700 may include an object recognition model. The object recognition model may analyze and classify an object using clustered point cloud as input. The object recognition model may output probability values of the object in the point cloud data belonging to each class corresponding to a category of the object. Through the output value of the object recognition model, it may be determined which class the object belongs to. The object recognition model may extract features from the point cloud data and classify the class of the object based on the extracted features. For example, the object recognition model may obtain a position and feature values where an object is estimated to are present in an image, and classify the class of the object by computing the obtained feature values along nodes and edges included in each layer of fully connected layers. The object recognition model may output probability values calculated for each class using an activation function such as a SoftMax function.

The object recognition model may output top n values among probability values (or scores) for each class of all objects that the object recognition model may recognize as an object recognition result. The output value means that the larger the value, the higher the possibility that the object is of that class. However, the output value should be greater than a predetermined threshold, which is a criterion for determining whether the object recognition result is reliable. For example, the object recognition model may output ‘0.35’, ‘0.15’, ‘0.13’, ‘0.11’, and ‘0.1’ as probability values for the top 5 classes as an object recognition result. In this case, in case that the predetermined threshold for determining whether the object recognition result is reliable is ‘0.4’, since no output probability value is greater than ‘0.4’, object recognition through the object recognition model may be processed as failed.

According to an embodiment, the object recognition model may include a person recognition model. The refrigerator 1 may recognize a person using the person recognition model in a frame.

According to an embodiment, the refrigerator 1 may collect gesture data of a user using a sensor (e.g., the sensor 162 of FIG. 4). The gesture data may be point cloud data. The refrigerator 1 may extract features of a gesture from the point cloud data and identify the gesture based on the extracted features of the gesture.

According to an embodiment, the refrigerator 1 may extract features of a gesture using skeleton analysis and identify the gesture based on the extracted features of the gesture. Skeleton analysis is a process of extracting a human body structure and analyzing it to identify a gesture. The refrigerator 1 may extract positions of major body joints (e.g., head, elbow, knee) of a person and identify them as skeleton points. For example, the refrigerator 1 may extract positions of major body joints using a skeleton tracking model or a pose estimation model (e.g., OpenPose, HRNet).

The refrigerator 1 may track movement of the skeleton. For example, the refrigerator 1 may track position changes and speed of skeleton points. The refrigerator 1 may identify a gesture of a person based on the tracked movement of the skeleton. For example, the refrigerator 1 may identify a gesture of a person based on position changes and speed of tracked skeleton points. The refrigerator 1 may track movement of the skeleton based on a plurality of frames and identify a gesture based on the tracked movement of the skeleton. The refrigerator 1 may extract features of the movement of the skeleton. For example, the refrigerator 1 may use relative distances or angles between specific joints (e.g., distance between wrist and shoulder, angle between elbow and knee) as features of the shape of the skeleton. For example, the refrigerator 1 may extract speed and acceleration where joint positions change over time as features of the movement of the skeleton. The refrigerator 1 may label gestures so that the artificial intelligence model 700 may learn skeleton shapes or movement patterns related to specific gestures. For example, the refrigerator 1 may assign labels such as “arm waving gesture,” “hand raising gesture,” or “foot moving gesture” corresponding to gestures.

The refrigerator 1 may learn characteristics of the skeleton. The refrigerator 1 may identify a gesture of the user from the point cloud data based on the characteristics of the skeleton. For example, the refrigerator 1 may store skeleton data identified from the point cloud data in a memory 192. The skeleton data may include positions of joints included in the skeleton or relationships between joints. As skeleton data is accumulated and stored in the memory 192, a database of the user's skeleton may be created. The refrigerator 1 may analyze positions of joints and/or relationships between joints from the database of the user's skeleton stored in the memory 192. The refrigerator 1 may learn unique characteristics of the user's skeleton that are distinguished from skeletons of other users using at least one artificial intelligence model 700. The refrigerator 1 may quickly and accurately identify a gesture of the user from sensing data obtained by the sensor 162 based on the learned characteristics of the skeleton.

The refrigerator 1 may learn a specific gesture using the artificial intelligence model 700. The refrigerator 1 may collect gesture data using a sensor (e.g., the sensor 162 of FIG. 4). The gesture data may be point cloud data. The refrigerator 1 may identify and classify a specific gesture based on the gesture data using the artificial intelligence model 700. The artificial intelligence model 700 may learn spatial and temporal features of a gesture. The artificial intelligence model 700 may identify patterns related to a gesture through input data. For example, the artificial intelligence model 700 may receive feature data such as coordinates, distances, angles, or speeds of skeleton points as input, and learn gesture classes (e.g., hand waving, clapping) as output labels. For example, the artificial intelligence model 700 may include RNN/LSTM that processes time series data to learn temporal continuity of joint movements, GCN (Graph Convolutional Network) that represents a skeleton as a graph to learn relationships between joints, or 3D CNN that processes temporal-spatial movements of joints in video data. The artificial intelligence model 700 may enhance gesture recognition rate through an iterative learning process.

The refrigerator 1 may quickly and accurately identify gestures using the learned artificial intelligence model 700. The artificial intelligence model 700 may receive real-time sensing data from a sensor as input. Real-time data may be preprocessed (e.g., noise removal). The artificial intelligence model 700 may output labels corresponding to gestures in real-time.

The refrigerator 1 may determine user characteristics from point cloud data obtained based on the sensor 162. For example, the refrigerator 1 may determine user characteristics by analyzing skeleton characteristics of the user (e.g., positions of joints, relationships between joints). For example, the user characteristics may include at least one of the gender or age of the user.

The refrigerator 1 may identify a restricted user based on the user characteristics. For example, a restricted user may include a child user and/or an elderly user. The refrigerator 1 may deactivate an automatic door opening function in case of being determined as a restricted user based on the user characteristics. For example, the refrigerator 1 may deactivate the automatic door opening function in case of identifying an animal.

According to an embodiment, the refrigerator 1 may identify a gesture of the user with high accuracy by detecting the gesture of the user based on the point cloud data. According to an embodiment, the refrigerator 1 may increase the accuracy of determining the gesture of the user by learning characteristics of the user. The refrigerator 1 may increase convenience and efficiency in using the refrigerator 1 by automatically opening a door according to the user's intention. The refrigerator 1 may identify a restricted user and/or an animal based on the point cloud data. The refrigerator 1 may provide safety in use by deactivating the automatic door opening function in case that a gesture of a restricted user and/or an animal is identified.

According to an embodiment, the refrigerator 1 may distinguish users based on high-resolution point cloud data. The refrigerator 1 may perform customized operations (functions) designated for each user (e.g., display/interface personalization, food/ingredient recommendations according to preferences, etc.).

According to an embodiment, the refrigerator 1 may obtain skeleton data from the point cloud data using the artificial intelligence model 700. For example, the skeleton data may include at least one of 3D joint coordinates, skeleton shape, or movement patterns of the skeleton. The refrigerator 1 may infer an intended gesture based on the skeleton data using the artificial intelligence model 700. The intended gesture may be a gesture actually performed by a user to provide a preset gesture (e.g., a first gesture) to the refrigerator 1. For example, the refrigerator 1 may determine that the intended gesture is the first gesture in case that the intended gesture exhibits a degree of match with the preset first gesture above a threshold.

The refrigerator 1 may open the first door based on determining that the gesture of the user is the first gesture for opening a door. For example, the door control module 150 may automatically open the selected door using the rotational force of the motor. The refrigerator 1 may provide a visual notification or an auditory notification indicating that a door has been opened.

FIG. 8 is a block diagram illustrating a configuration of a radar sensor according to an example.

Referring to FIG. 8, a radar sensor (e.g., the sensor 162 of FIG. 4) may include a transmitter 810, a receiver 820, and a signal processing unit 830. The radar sensor may transmit electromagnetic waves to an object and receive reflected signals to obtain at least one of distance, direction, or speed with the object. The radar sensor may obtain 3D position information of the object by combining at least one of distance, direction, or speed with the object.

The transmitter 810 may transmit an electromagnetic wave signal through at least one transmission antenna 811. Hereinafter, a signal transmitted by the transmitter 810 may be referred to as a transmission signal. The electromagnetic wave signal may be reflected at interfaces between materials of an object (e.g., a person, an animal, metal). The receiver 820 may receive a reflected signal through at least one reception antenna 821. Hereinafter, a signal received by the receiver 820 may be referred to as a reception signal.

The signal processing unit 830 may process a radar signal and output the processing result to a processor (e.g., the processor 191 of FIG. 4). The signal processing unit 830 may include at least one of a mixer 831, a low pass filter 832, an analog-to-digital converter (ADC) 833, or a fast-time Fourier (FTF) signal processing unit 834. The signal processing unit 830 may estimate a distance to an object by analyzing radar data sensed through the radar sensor. The signal processing unit 830 may estimate a speed of an object by analyzing radar data sensed through the radar sensor. The signal processing unit 830 may estimate a direction of an object based on reception signals corresponding to each reception antenna of the radar sensor. The signal processing unit 830 may obtain a position (x, y, z coordinates) of an object in three-dimensional space by combining at least one of distance, direction, or speed with the object.

The mixer 831 may mix a radar transmission signal and a radar reflection signal to generate an intermediate frequency (IF) signal based on a difference between the transmission signal and the reception signal. The mixer 831 may generate a frequency difference between the transmission signal and the reception signal as an IF signal. The low pass filter 832 may filter a signal in a low frequency band among the IF signal to reduce noise of high frequency components included in the IF signal. The analog-to-digital converter 833 may convert the low-pass filtered IF signal into a digital signal.

The FTF signal processing unit 834 may include at least one of a range fast Fourier transform (FFT) signal processing unit, a Doppler shift FFT signal processing unit, a constant false alarm rate (CFAR) signal processing unit, and an angle of arrival FFT signal processing unit. The range FFT signal processing unit may estimate a distance to an object. The range FFT signal processing unit may extract frequency information along a time axis by converting a signal collected in a time domain to a frequency domain. A frequency difference between a reception signal and a transmission signal may be proportional to a distance to an object. The range FTF signal processing unit may estimate a distance to an object based on a frequency difference between a reception signal and a transmission signal. The Doppler shift FFT signal processing unit may estimate a speed of an object using a frequency change while transmitting a transmission signal and a signal reflected from the object returns. The CFAR signal processing unit may filter noise (e.g., signals generated from backgrounds other than the object) included in a reception signal. The angle of arrival FFT signal processing unit may estimate a direction of an object (in which direction the object is positioned relative to the radar sensor) using an angle where a reception signal arrives at a plurality of radar sensors.

The refrigerator 1 (e.g., the processor 191) may recognize an object based on a radar signal received through the signal processing unit 830 or on a processing result thereof. The radar sensor may provide high-resolution 3D data (point cloud data). The refrigerator 1 may obtain very precise 3D data using the radar sensor. For example, the refrigerator 1 may identify objects separated by 10 cm or more as different objects using the radar sensor. The refrigerator 1 may identify a gesture of a user with high accuracy by detecting the gesture of the user based on point cloud data obtained by the radar sensor.

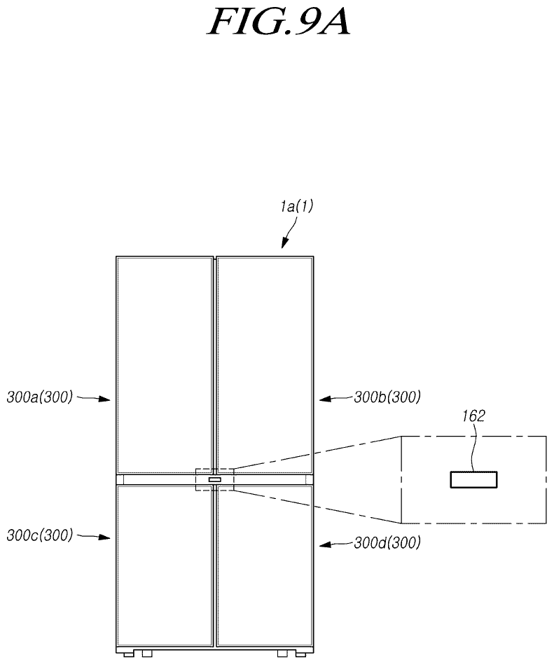

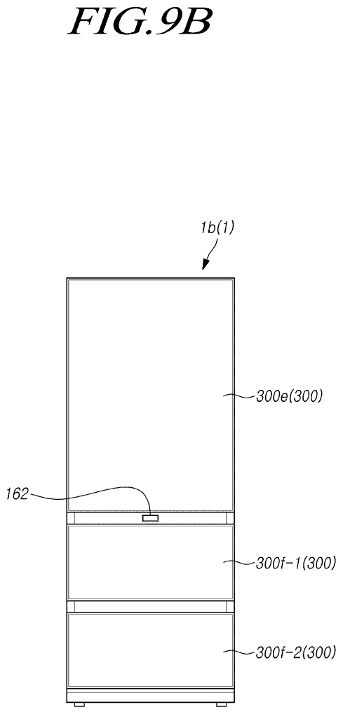

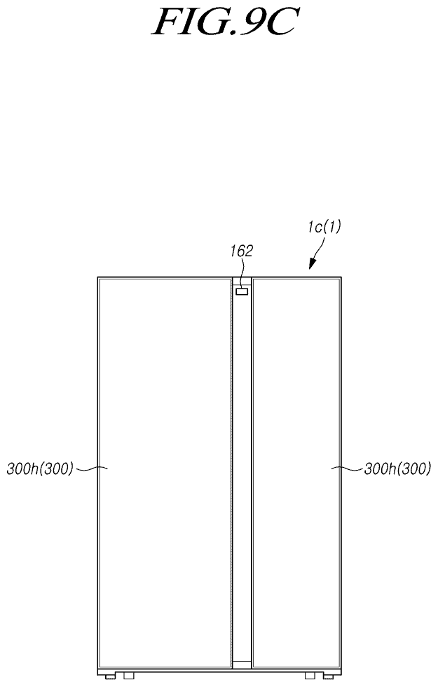

FIGS. 9A to 9C are example views illustrating an arrangement of the sensor 162 according to an example of the disclosure.

In FIGS. 9A to 9C, the sensor 162 may be disposed at various positions of the refrigerator 1. The sensor 162 may be disposed at various positions according to the type of the refrigerator 1. The refrigerator 1 may be classified by type according to the form of storage compartments and doors. For example, the refrigerator may be a French door refrigerator (FDR) type refrigerator 1a (see FIG. 9A), a top mounted freezer (TMF) type refrigerator or a bottom mounted freezer (BMF) type refrigerator 1b (see FIG. 9B), or a side by side (SBS) type refrigerator 1c (see FIG. 9C). In the FDR type refrigerator 1a, a storage compartment is divided up and down by a horizontal partition wall, a refrigerating compartment is formed on the upper side, a freezing compartment is formed on the lower side, and the upper refrigerating compartment may be opened and closed by a pair of doors. In the TMF type refrigerator, a storage compartment may be divided up and down by a horizontal partition wall, with a freezing compartment formed on the upper side and a refrigerating compartment formed on the lower side. In the BMF type refrigerator 1b, a storage compartment may be divided up and down by a horizontal partition wall, with a refrigerating compartment formed on the upper side and a freezing compartment formed on the lower side. The TMF type refrigerator and the BMF type refrigerator are similar in form in that storage compartments are divided up and down by a horizontal partition wall, and differ in that the freezing compartment is positioned on the upper side in the TMF type refrigerator and the freezing compartment is positioned on the lower side in the BMF type refrigerator. In the SBS type refrigerator 1c, a storage compartment may be divided left and right by a vertical partition wall, with a freezing compartment formed on one side and a refrigerating compartment formed on the other side. According to an embodiment, the refrigerator 1 may include a rotating door that rotates based on a side surface of the refrigerator 1. According to an embodiment, the refrigerator 1 may include a drawer-type door that is pulled out to the front of the refrigerator 1. For example, the refrigerator 1b may include at least one rotating door 300e that opens and closes a storage compartment positioned at the upper portion of the refrigerator 1b. For example, the refrigerator 1b may include at least one drawer-type door 300f-1; 300f-2 that opens and closes a storage compartment positioned at the lower portion of the refrigerator 1b. The refrigerator 1b may open and close the rotating door 300e and/or the drawer-type door 300f-1; 300f-2 using a door control module included in the refrigerator 1b.

As illustrated in FIG. 9A, the sensor 162 may be disposed between upper doors 300a; 300b and lower doors 300c; 300d. For example, the sensor 162 may be disposed on a frame between the upper doors 300a; 300b and the lower doors 300c; 300d. The sensor 162 may be formed at the center between the upper doors 300a; 300b and the lower doors 300c; 300d of the refrigerator 1a. The sensor 162 may be disposed on a lower side of the upper doors 300a; 300b. The sensor 162 may be disposed on an upper side of the lower doors 300c; 300d.

As illustrated in FIG. 9B, the sensor 162 may be disposed between an upper door 300e and a lower door 300f-1. The sensor 162 may be disposed on a frame between the upper door 300e and the lower door 300f-1. The sensor 162 may be disposed on a lower side of the upper door 300e. The sensor 162 may be disposed on an upper side of the lower door 300f-1.

As illustrated in FIG. 9C, the sensor 162 may be disposed on the upper side of the refrigerator 1c. The sensor 162 may be disposed on a frame between a left door 300g and a right door 300h.

The arrangement of the sensor 162 included in the refrigerator 1 according to an example of the disclosure is not limited to the positions illustrated in FIGS. 9A to 9C. Although only one sensor 162 is illustrated in FIGS. 9A to 9C, the sensor 162 may be additionally disposed at a position adjacent to or separated from the illustrated sensor 162.

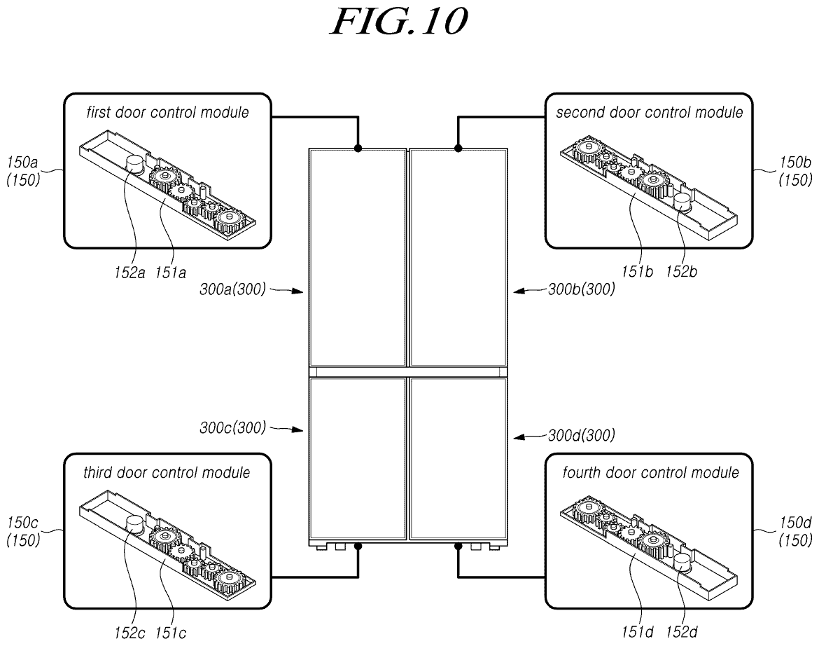

FIG. 10 is an example view illustrating the door control module 150 of the refrigerator 1 according to an example of the disclosure.

Referring to FIG. 10, the refrigerator 1 may include the door control module 150. The door control module 150 may control opening or closing of at least one door. The door control module 150 may include a motor driver 151 and a motor 152. For example, the door control module 150 may precisely control the movement of at least one door 300 according to whether at least one door 300 is opened or the degree of opening.

The motor driver 151 may control the motor. For example, the motor driver 151 may activate or deactivate the motor 152. For example, the motor driver 151 may control the operation state of the motor 152 by supplying or cutting off power to the motor 152.

The motor 152 may open at least one door by rotating. For example, the motor 152 may be activated based on the control of the motor driver, thereby opening at least one door. For example, the motor 152 may be deactivated based on the control of the motor driver, thereby closing at least one door.

As illustrated in FIG. 10, the door control module 150 may include a plurality of door control modules corresponding to each of at least one door 300. For example, the door control module 150 may include a first door control module 150a to a fourth door control module 150d. Each of the first door control module 150a to the fourth door control module 150d may include a motor driver 151 and a motor 152 for controlling the opening and closing of at least one door 300.

The first door control module 150a may be formed on an upper frame adjacent to the left upper door 300a to control opening or closing of the left upper door 300a. For example, the first motor driver 151a may control the opening or closing of the left upper door 300a by receiving a door control signal from the processor 191 and activating or deactivating the first motor 152a based on the door control signal.

The second door control module 150b may be formed on an upper frame adjacent to the right upper door 300b to control opening or closing of the right upper door 300b. For example, the second motor driver 151b may control the opening or closing of the right upper door 300b by receiving a door control signal from the processor 191 and activating or deactivating the second motor 152b based on the door control signal.

The third door control module 150c may be formed on a lower frame adjacent to the left lower door 300c to control opening or closing of the left lower door 300c. For example, the third motor driver 151c may control the opening or closing of the left lower door 300c by receiving a door control signal from the processor 191 and activating or deactivating the third motor 152c based on the door control signal.

The fourth door control module 150d may be formed on a lower frame adjacent to the right lower door 300d to control opening or closing of the right lower door 300d. For example, the fourth motor driver 151d may control the opening or closing of the lower right door 300d by receiving a door control signal from the processor 191 and activating or deactivating the fourth motor 152d based on the door control signal.

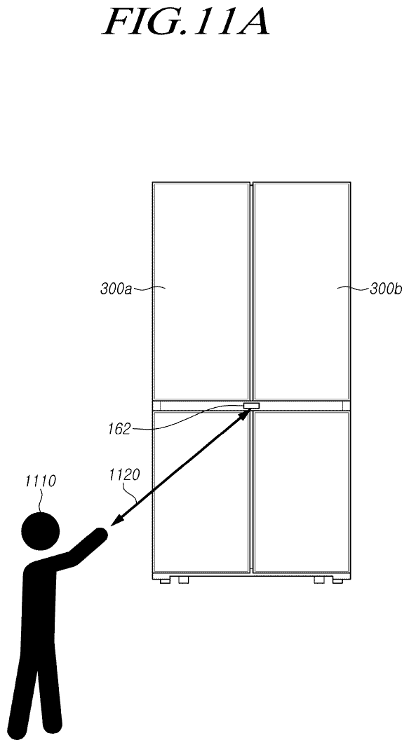

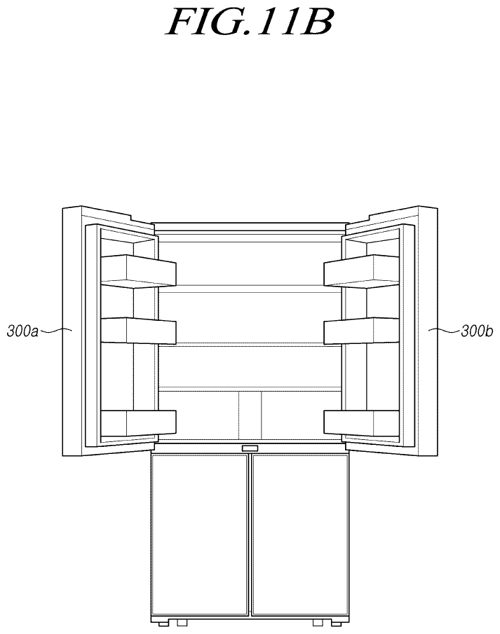

FIGS. 11A and 11B illustrate an automatic door opening method of the refrigerator 1 according to an example.

Referring to FIGS. 11A and 11B, the refrigerator 1 may identify a gesture of a user 1110 positioned within a first distance 1120 from the refrigerator 1. The refrigerator 1 may open a first door based on the identified gesture being identified as a first gesture.

In FIG. 11A, the refrigerator 1 may identify a gesture of the user 1110 positioned within the first distance 1120 from the refrigerator 1. The refrigerator 1 may obtain point cloud data using at least one sensor 162. The point cloud data may include information about movement of a plurality of points corresponding to an object positioned within the first distance 1120 from the refrigerator 1. The refrigerator 1 may identify a gesture of the user 1110 positioned within the first distance 1120 from the refrigerator 1 based on the obtained point cloud data. For example, as described with reference to FIGS. 6 and 7, the refrigerator 1 may identify a gesture of the user 1110 based on the point cloud data. For example, the refrigerator 1 may cluster a point cloud of the user 1110 from the point cloud data. The refrigerator 1 may detect a skeleton of the user 1110 from the point cloud of the user 1110. The refrigerator 1 may track movement of the skeleton. The refrigerator 1 may identify the gesture of the user based on the movement of the skeleton. For example, the user 1110 may make a gesture of raising a hand (left hand and/or right hand) from bottom to top above a threshold. The refrigerator 1 may identify a gesture of raising a hand from bottom to top above a threshold.

In FIG. 11B, the refrigerator 1 may open a first door based on the identified gesture being identified as a first gesture. The first gesture may be a preset gesture for opening the first door. For example, the first gesture may be a gesture of raising a hand from bottom to top. The refrigerator 1 may infer a gesture (e.g., the first gesture) that the user intends to provide based on the point cloud data using an artificial intelligence model trained to identify a gesture of the user. The refrigerator 1 may open the first door in case of identifying the first gesture. In an embodiment, the refrigerator 1 may preset the first door. For example, the refrigerator 1 may set upper doors 300a; 300b as the first door. In an embodiment, the refrigerator 1 may set the first door according to a user input. For example, the refrigerator 1 may set, according to a user input, an upper door 300a or 300b which is close to a hand raised from bottom to top as the first door. The refrigerator 1 may provide a user interface for setting the first door.

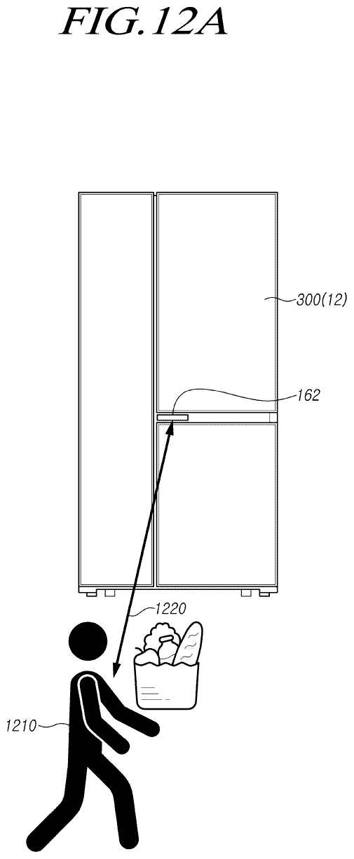

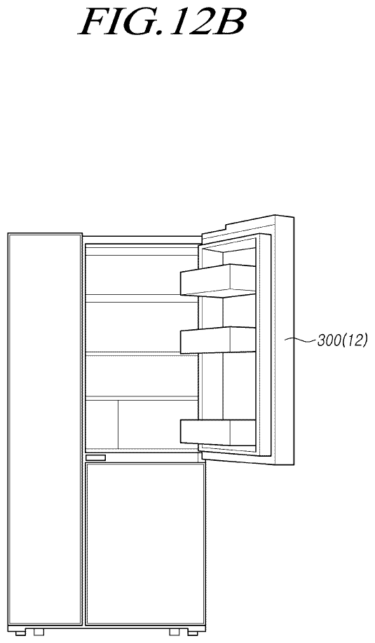

FIGS. 12A and 12B illustrate an automatic door opening method of the refrigerator 1 according to an example.

Referring to FIGS. 12A and 12B, the refrigerator 1 may identify a gesture of a user 1210 positioned within a first distance 1220 from the refrigerator 1. The refrigerator 1 may open a first door based on the identified gesture being identified as a first gesture.

In FIG. 12A, the refrigerator 1 may identify a gesture of the user 1210 positioned within the first distance 1220 from the refrigerator 1. For example, the user 1210 may make a gesture of moving a foot. The refrigerator 1 may identify a gesture of moving a foot. The gesture identification method in FIG. 12A is substantially the same as or overlaps the gesture identification method in FIG. 11A, so the description is omitted.

In FIG. 12B, the refrigerator 1 may open a first door based on the identified gesture being identified as a first gesture. For example, the first gesture may be a gesture of moving a foot. For example, the first gesture may be a gesture of moving a foot from left to right. For example, the first gesture may be a gesture of moving a foot from right to left. The refrigerator 1 may preset the first door. For example, the refrigerator 1 may set a right upper door 300(12) as the first door. The refrigerator 1 may set the first door according to a user input. For example, the refrigerator 1 may set a door on the side where foot movement stopped as the first door according to a user input. For example, in case that the first gesture is a gesture of moving a foot from left to right, a door on the right side where the foot stopped (e.g., the right upper door 300(12)) may be set as the first door. The refrigerator 1 may provide a user interface for setting the first door.

For example, the user 1210 may be carrying items in the hands. The user 1210 may conveniently open a door using the foot even while carrying items in the hands.

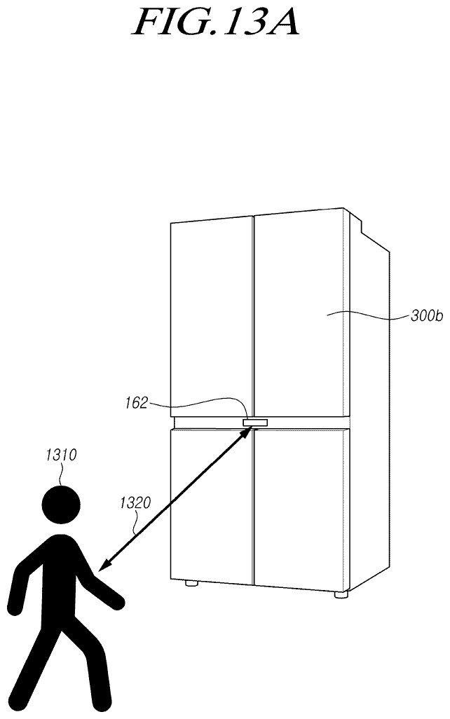

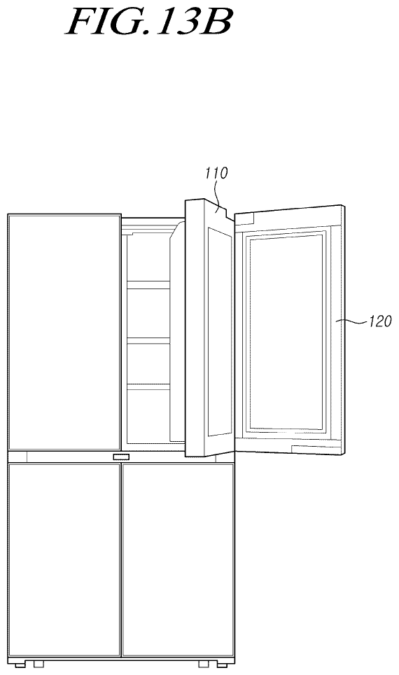

FIGS. 13A and 13B illustrate an automatic door opening method of the refrigerator 1 according to an example.

Referring to FIGS. 13A and 13B, the refrigerator 1 may identify a gesture of a user 1310 positioned within a first distance 1320 from the refrigerator 1. The refrigerator 1 may open a first door based on the identified gesture being identified as a first gesture.

In FIG. 13A, the refrigerator 1 may identify a gesture of the user 1310 positioned within the first distance 1320 from the refrigerator 1. For example, the user 1310 may make a gesture of reaching a hand toward a door. The refrigerator 1 may identify a gesture of reaching a hand toward a door. The gesture identification method in FIG. 13A is substantially the same as or overlaps the gesture identification method in FIG. 11A, so the description is omitted.

In FIG. 13B, the refrigerator 1 may open a first door based on the identified gesture being identified as a first gesture. For example, the first gesture may be a gesture of reaching a hand toward a door. The refrigerator 1 may preset the first door. For example, the refrigerator 1 may set a right upper door 300b as the first door. The right upper door 300b may include an inner door 110 and an outer door 120. For example, the refrigerator 1 may set the inner door 110 and/or the outer door 120 as the first door. For example, the refrigerator 1 may open the inner door 110 and/or the outer door 120 in response to the first gesture. The refrigerator 1 may set the first door according to a user input. For example, the refrigerator 1 may set a door toward which a hand is directed as the first door. For example, in case that the first gesture is a gesture of reaching a hand toward the right upper door 300b, the right upper door 300b may be set as the first door. The refrigerator 1 may provide a user interface for setting the first door.

The user 1310 may conveniently open a door using an intuitive gesture (e.g., a gesture of reaching a hand toward a door).

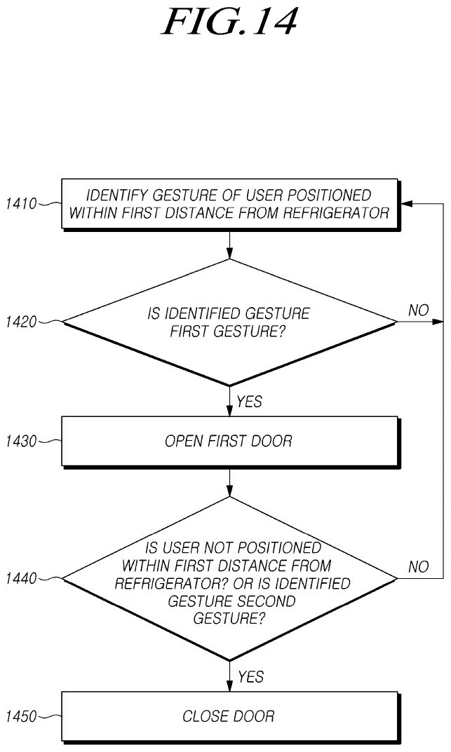

FIG. 14 is a flowchart illustrating an operation of a refrigerator according to an example of the disclosure.

In the following operation examples, each operation may be sequentially performed, but is not necessarily performed sequentially. For example, the order of each operation may be changed, or at least two operations may be performed in parallel. At least some of the operations may be performed on a server.

The refrigerator 1 may identify a gesture of a user positioned within a first distance from the refrigerator in operation 1410. The refrigerator 1 may determine whether the identified gesture is a first gesture in operation 1420. The refrigerator 1 may open a first door in case that the identified gesture is the first gesture in operation 1430. The refrigerator 1 may return to operation 1410 in case that the identified gesture is not the first gesture. Operations 1410 to 1430 are substantially the same as or overlap operations 510 to 530 of FIG. 5, so the description is omitted.

The refrigerator 1 may determine whether the user is not positioned within the first distance from the refrigerator in operation 1440. The refrigerator 1 may identify a user positioned within the first distance from the refrigerator. For example, the refrigerator 1 may obtain point cloud data using at least one sensor (e.g., the sensor 162 of FIG. 4). The refrigerator 1 may identify a user positioned within the first distance from the refrigerator based on the obtained point cloud data. The refrigerator 1 may determine that the user is not positioned within the first distance from the refrigerator in case that a user positioned within the first distance from the refrigerator is not identified.

In case that a user positioned within the first distance from the refrigerator identified, the refrigerator 1 may identify a gesture of the user and determine whether the identified gesture is a second gesture in operation 1440. The second gesture may be a preset gesture for closing at least one door included in the refrigerator. In operation 1440, the method in which the refrigerator 1 identifies a gesture and determines a gesture (e.g., the second gesture) that the user intends to provide is substantially the same as or overlaps the gesture identification method in operations 520 and 530 of FIG. 5, so the description is omitted. The refrigerator may return to operation 1410 in case that the identified gesture is not the second gesture.

The refrigerator 1 may close at least one door included in the refrigerator 1 in case that the user is not positioned within the first distance from the refrigerator in operation 1450. The refrigerator 1 may close at least one door included in the refrigerator 1 based on identifying that the user is not positioned within the first distance from the refrigerator for at least a designated time (e.g., 3 seconds). The refrigerator 1 may close at least one door included in the refrigerator 1 in case that the identified gesture is the second gesture in operation 1450. The door to be closed may be the first door. The doors to be closed may be all doors that are open in the refrigerator 1.

In an embodiment, the refrigerator 1 may include at least one storage compartment 20, at least one door 300 for opening and closing the at least one storage compartment, a door control module 150 for controlling opening or closing of the at least one door, at least one sensor 162, and at least one processor 191. The at least one processor may be configured to obtain point cloud data using the at least one sensor, identify a gesture of a user positioned within a first distance from the refrigerator based on the point cloud data, and control the door control module to open a first door selected from among the at least one door based on the identified gesture being identified as a first gesture.

In an embodiment, the at least one processor may be configured to cluster a point cloud of the user from the point cloud data, detect a skeleton of the user from the point cloud of the user, track movement of the skeleton, detect a feature of the movement of the skeleton, and identify the gesture of the user based on the feature of the movement of the skeleton.

In an embodiment, the at least one processor may be configured to learn characteristics of the skeleton of the user, and identify the gesture of the user from the point cloud data based on the characteristics of the skeleton.

In an embodiment, the at least one processor may be configured to identify the gesture of the user by inferring a gesture that the user intends to provide based on the point cloud data using an artificial intelligence model trained to identify the gesture of the user.

In an embodiment, the at least one processor may be configured to identify the gesture of the user after identifying that the user is positioned within the first distance for at least a designated time based on the point cloud data.

In an embodiment, the at least one processor may be configured to provide a user interface for selecting the first door to be opened in response to the first gesture among the at least one door.

In an embodiment, the at least one processor may be configured to detect a restricted user based on the point cloud data, and deactivate a door opening function in case of detecting the first gesture of the restricted user.

In an embodiment, the at least one processor may be configured to control the door control module to close the at least one door based on identifying that the user is not positioned within the first distance from the refrigerator.

In an embodiment, the at least one processor may be configured to control the door control module to close the at least one door based on the gesture of the user being identified as a second gesture.

In an embodiment, the at least one sensor may include at least one of a radar sensor, an optical sensor, or an ultrasonic sensor.

In an embodiment, a method of controlling a refrigerator 1 may include obtaining point cloud data using at least one sensor, identifying a gesture of a user positioned within a first distance from the refrigerator based on the point cloud data, and opening a first door based on the identified gesture being identified as a first gesture.

In an embodiment, the identifying the gesture of the user may include clustering a point cloud of the user from the point cloud data, detecting a skeleton of the user from the point cloud of the user, tracking movement of the skeleton, detecting features of the movement of the skeleton, and identifying the gesture of the user based on the feature of the movement of the skeleton.

In an embodiment, the identifying the gesture of the user may include learning characteristics of the skeleton of the user, and identifying the gesture of the user from the point cloud data based on the characteristics of the skeleton.

In an embodiment, the identifying the gesture of the user may include inferring a gesture that the user intends to provide based on the point cloud data using an artificial intelligence model trained to identify the gesture of the user.

In an embodiment, the identifying the gesture of the user may include identifying the gesture of the user after identifying that the user is positioned within the first distance for at least a designated time based on the point cloud data.

In an embodiment, the method of controlling the refrigerator may include providing a user interface for selecting the first door to be opened in response to the first gesture.

In an embodiment, the method of controlling the refrigerator may include detecting a restricted user based on the point cloud data, and deactivating a door opening function in case of detecting the first gesture of the restricted user.

In an embodiment, the method of controlling the refrigerator may include closing at least one door based on identifying that the user is not positioned within the first distance from the refrigerator.

In an embodiment, the method of controlling the refrigerator may include closing at least one door based on the gesture of the user being identified as a second gesture.

In an embodiment, in the method of controlling the refrigerator, the at least one sensor may include at least one of a radar sensor, an optical sensor, or an ultrasonic sensor.

In an embodiment, a refrigerator may comprise at least one storage compartment; at least one door configured to open and close the at least one storage compartment; at least one sensor; and at least one processor configured to: obtain point cloud data using the at least one sensor, identify a gesture of a user positioned within a first distance from the refrigerator based on the point cloud data, and perform control to open a door from among the at least one door based on the gesture being identified.

In an embodiment, the at least one processor may be configured to: cluster a point cloud of the user from the point cloud data, detect a skeleton of the user from the point cloud of the user, track movement of the skeleton, detect a feature of the movement of the skeleton, and identify the gesture of the user based on the feature of the movement of the skeleton.

In an embodiment, the at least one processor may be configured to: learn characteristics of the skeleton of the user, and identify the gesture of the user from the point cloud data based on the characteristics of the skeleton.

In an embodiment, the at least one processor may be configured to: identify the gesture of the user by inferring a gesture that the user intends to provide based on the point cloud data, using an artificial intelligence model trained to identify the gesture of the user.

In an embodiment, the at least one processor may be configured to: identify the gesture of the user after identifying that the user is positioned within the first distance for at least a designated time based on the point cloud data.

In an embodiment, the at least one door may include a plurality of doors, and the at least one processor is configured to: provide a user interface for selecting the door to be opened from among the plurality of doors in response to the gesture.

In an embodiment, the at least one processor may be configured to: detect a restricted user based on point cloud data obtained using the at least one sensor, and deactivate a door opening function in case of detecting the gesture of the restricted user.

In an embodiment, the at least one processor may be configured to, with the door open: perform control to close the door based on identifying that the user is not positioned within the first distance from the refrigerator.

In an embodiment, the gesture is a first gesture, and the at least one processor may be configured to, with the door open: obtain additional cloud point data using the at least one sensor, identify a second gesture of the user positioned within the first distance from the refrigerator based on the additional cloud point data, and perform control to close the door based on the second gesture of the user being identified.

In an embodiment, the at least one sensor may include at least one of a radar sensor, an optical sensor, or an ultrasonic sensor.

In an embodiment, the at least one door may include a plurality of doors, the door is a first door of the plurality of doors, the gesture is a first gesture for opening the first door, and the at least one processor may be configured to: identify a second gesture, different than the first gesture, of the user positioned within the first distance from the refrigerator based on cloud point data obtained using the at least one sensor, the second gesture being a gesture for opening a second door from among the plurality of doors, and perform control to open the second door based on the second gesture being identified.

In an embodiment, a method of controlling a refrigerator, may comprise: obtaining point cloud data using at least one sensor; identifying a gesture of a user positioned within a first distance from the refrigerator based on the point cloud data; and opening a door of the refrigerator based on the gesture being identified.

In an embodiment, the identifying the gesture of the user may include: clustering a point cloud of the user from the point cloud data, detecting a skeleton of the user from the point cloud of the user, tracking movement of the skeleton, detecting a feature of the movement of the skeleton, and identifying the gesture of the user based on the feature of the movement of the skeleton.

In an embodiment, the identifying the gesture of the user may include: learning characteristics of the skeleton of the user, and identifying the gesture of the user from the point cloud data based on the characteristics of the skeleton. 15. The method of claim 12, wherein the identifying the gesture of the user includes: inferring a gesture that the user intends to provide based on the point cloud data, using an artificial intelligence model trained to identify the gesture of the user.

In an embodiment, the identifying the gesture of the user may include: identifying the gesture of the user after identifying that the user is positioned within the first distance for at least a designated time based on the point cloud data.

In an embodiment, the refrigerator may include a plurality of doors, and the method may further comprise: providing a user interface for selecting the door to be opened from among the plurality of doors in response to the gesture.

In an embodiment, the method may further comprise: detecting a restricted user based on point cloud data obtained by the at least one sensor; and deactivating a door opening function in case of detecting the gesture of the restricted user.

In an embodiment, the method may further comprise, with the door open: closing the door based on identifying that the user is not positioned within the first distance from the refrigerator.

In an embodiment, the gesture is a first gesture, and the method may further comprise, with the door open: obtaining additional cloud point data using the at least one sensor, identifying a second gesture of the user positioned within the first distance from the refrigerator based on the additional cloud point data, and closing the door based on the second gesture being identified.

In an embodiment, the at least one sensor may include at least one of a radar sensor, an optical sensor, or an ultrasonic sensor.

In an embodiment, the refrigerator may include a plurality of doors, the door is a first door of the plurality of doors, the gesture is a first gesture for opening the first door, and the method may further comprise: identifying a second gesture, different than the first gesture, of the user positioned within the first distance from the refrigerator based on cloud point data obtained using the at least one sensor, the second gesture being a gesture for opening a second door from among the plurality of doors, and opening the second door based on the second gesture being identified.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A refrigerator comprising:
at least one storage compartment;
at least one door configured to open and close the at least one storage compartment;
at least one sensor; and
at least one processor configured to:
obtain point cloud data using the at least one sensor,
identify a gesture of a user positioned within a first distance from the refrigerator based on the point cloud data, and
perform control to open a door from among the at least one door based on the gesture being identified.

2. The refrigerator of claim 1, wherein the at least one processor is configured to:
cluster a point cloud of the user from the point cloud data,
detect a skeleton of the user from the point cloud of the user,
track movement of the skeleton,
detect a feature of the movement of the skeleton, and
identify the gesture of the user based on the feature of the movement of the skeleton.

3. The refrigerator of claim 2, wherein the at least one processor is configured to:
learn characteristics of the skeleton of the user, and
identify the gesture of the user from the point cloud data based on the characteristics of the skeleton.

4. The refrigerator of claim 1, wherein the at least one processor is configured to:
identify the gesture of the user by inferring a gesture that the user intends to provide based on the point cloud data, using an artificial intelligence model trained to identify the gesture of the user.

5. The refrigerator of claim 1, wherein the at least one processor is configured to:
identify the gesture of the user after identifying that the user is positioned within the first distance for at least a designated time based on the point cloud data.

6. The refrigerator of claim 1, wherein
the at least one door includes a plurality of doors, and
the at least one processor is configured to:
provide a user interface for selecting the door to be opened from among the plurality of doors in response to the gesture.

7. The refrigerator of claim 1, wherein the at least one processor is configured to:
detect a restricted user based on point cloud data obtained using the at least one sensor, and
deactivate a door opening function in case of detecting the gesture of the restricted user.

8. The refrigerator of claim 1, wherein the at least one processor is configured to, with the door open:
perform control to close the door based on identifying that the user is not positioned within the first distance from the refrigerator.

9. The refrigerator of claim 1, wherein
the gesture is a first gesture, and
the at least one processor is configured to, with the door open:
obtain additional cloud point data using the at least one sensor,
identify a second gesture of the user positioned within the first distance from the refrigerator based on the additional cloud point data, and
perform control to close the door based on the second gesture of the user being identified.

10. The refrigerator of claim 1, wherein the at least one sensor includes at least one of a radar sensor, an optical sensor, or an ultrasonic sensor.

11. The refrigerator of claim 1, wherein
the at least one door includes a plurality of doors,
the door is a first door of the plurality of doors,
the gesture is a first gesture for opening the first door, and
the at least one processor is configured to:
identify a second gesture, different than the first gesture, of the user positioned within the first distance from the refrigerator based on cloud point data obtained using the at least one sensor, the second gesture being a gesture for opening a second door from among the plurality of doors, and
perform control to open the second door based on the second gesture being identified.

12. A method of controlling a refrigerator, the method comprising:
obtaining point cloud data using at least one sensor;
identifying a gesture of a user positioned within a first distance from the refrigerator based on the point cloud data; and
opening a door of the refrigerator based on the gesture being identified.

13. The method of claim 12, wherein the identifying the gesture of the user includes:
clustering a point cloud of the user from the point cloud data,
detecting a skeleton of the user from the point cloud of the user,
tracking movement of the skeleton,
detecting a feature of the movement of the skeleton, and
identifying the gesture of the user based on the feature of the movement of the skeleton.

14. The method of claim 13, wherein the identifying the gesture of the user includes:
learning characteristics of the skeleton of the user, and
identifying the gesture of the user from the point cloud data based on the characteristics of the skeleton.

15. The method of claim 12, wherein the identifying the gesture of the user includes:
inferring a gesture that the user intends to provide based on the point cloud data, using an artificial intelligence model trained to identify the gesture of the user.

16. The method of claim 12, wherein the identifying the gesture of the user includes:
identifying the gesture of the user after identifying that the user is positioned within the first distance for at least a designated time based on the point cloud data.

17. The method of claim 12, wherein
the refrigerator includes a plurality of doors, and
the method further comprising:
providing a user interface for selecting the door to be opened from among the plurality of doors in response to the gesture.

18. The method of claim 12, further comprising:
detecting a restricted user based on point cloud data obtained by the at least one sensor; and
deactivating a door opening function in case of detecting the gesture of the restricted user.

19. The method of claim 12, further comprising, with the door open:
closing the door based on identifying that the user is not positioned within the first distance from the refrigerator.

20. The method of claim 12, wherein
the gesture is a first gesture, and
the method further comprising, with the door open:
obtaining additional cloud point data using the at least one sensor,
identifying a second gesture of the user positioned within the first distance from the refrigerator based on the additional cloud point data, and
closing the door based on the second gesture being identified.
